(19) United States
(12) Patent Application Publication
(10) Pub. No.: US 2025/0054471 A1
(43) Pub. Date: Feb. 13, 2025

(54) ELECTRONIC APPARATUS FOR MUSICAL INSTRUMENTS

(71) Applicant: CASIO COMPUTER CO., LTD., Tokyo (JP)

(72) Inventors: Yasuhiro TSUYUKI, Tokyo (JP); Ryohei KOBAYASHI, Tokyo (JP)

(21) Appl. No.: 18/798,112

(22) Filed: Aug. 8, 2024

(30) Foreign Application Priority Data
Aug. 10, 2023 (JP) 2023-130580

(51) Int. Cl. G10H 1/00; G10G 5/00

(52) U.S. Cl. CPC G10H 1/0008; G10G 5/005; G10H 2220/201

(57) ABSTRACT

An electronic apparatus for musical instruments includes a first component configured to be coupled to a strap, a second component configured to be coupled to a musical instrument, a generator configured to generate a rotational movement in accordance with a distance between the first component and the second component, which is configured to change based on a tension applied to at least one of the first component or the second component, and a rotation detection device configured to detect a rotation amount of the rotational movement generated by the generator.

### CROSS-REFERENCE TO RELATED APPLICATION

This application is based upon and claims the benefit of priority under 35 USC 119 of Japanese Patent Application No. 2023-130580 filed on Aug. 10, 2023, the entire disclosure of which, including the specification, claims, drawings and abstract, is incorporated herein by reference in its entirety.

### BACKGROUND

### Technical Field

The present disclosure relates to an electronic apparatus for musical instruments.

### Description of the Related Art

There has conventionally been disclosed an electronic apparatus for musical instruments in which musical sound is controlled by applying a tension to a strap of a musical instrument. For example, Japanese Utility Model Publication No. 59-60692 discloses an electronic apparatus for musical instruments that controls musical sound by attaching an extension detection sensor to the strap of a portable electronic instrument equipped with a strap for standing playing, and using the sensor's output. Musical sound control can be performed by hanging the strap over the shoulder and pressing the instrument downward. The extension detection sensor attached to the strap detects the tension in the strap caused by pressing the instrument downward, and pitch bend, volume, etc., are adjusted according to this detected value.

### SUMMARY

According to an aspect of the present disclosure, there is provided electronic apparatus for musical instruments including a first component configured to be coupled to a strap, a second component configured to be coupled to a musical instrument, a generator configured to generate a rotational movement in accordance with a distance between the first component and the second component, which is configured to change based on a tension applied to at least one of the first component or the second component, and a rotation detection device configured to detect a rotation amount of the rotational movement generated by the generator.

### BRIEF DESCRIPTION OF THE DRAWINGS

FIG. 1 is a block diagram of a playing system including an electronic apparatus for musical instruments according to a first embodiment of the present disclosure;

FIG. 2 is a perspective view of the electronic apparatus for musical instruments according to the first embodiment of the present disclosure as viewed from a front side thereof;

FIG. 3 is an exploded perspective view of the electronic apparatus for musical instruments according to the first embodiment of the present disclosure;

FIG. 4 is a front view of the electronic apparatus for musical instruments according to the first embodiment of the present disclosure with a front case and an electronic circuit board omitted from illustration;

FIG. 5 is a perspective view of the electronic apparatus for musical instruments according to the first embodiment of the present disclosure with a periphery of a movable element shown in an enlarged view and a lever shown in cross-section;

FIG. 6A is a perspective view of the electronic apparatus for musical instruments according to the first embodiment of the present disclosure as seen from a direction P in FIG. 5 with a rotation detection device omitted from illustration;

FIG. 6B is a perspective view of an angle controller of the electronic apparatus for musical instruments according to the first embodiment of the present disclosure;

FIG. 7 is a perspective view of a main part of the electronic apparatus for musical instruments according to the first embodiment of the present disclosure which describes a control of an orientation of a case by changing over grooves of the angle controller with which a pin is brought into engagement;

FIG. 8 is a perspective view of the electronic apparatus for musical instruments according to the first embodiment of the present disclosure with a periphery of a stationary element shown in an enlarged view and one of sliding elements shown in cross-section;

FIG. 9 is a cross-sectional view of the electronic apparatus for musical instruments according to the first embodiment of the present disclosure which corresponds to a cross-section taken along a line IX-IX in FIG. 4;

FIG. 10 is a front view of the electronic apparatus for musical instruments according to the first embodiment of the present disclosure which shows a state in which the movable element has moved, with the front case and the electronic circuit board omitted from illustration;

FIG. 11 is a perspective view showing a main part of a first component of the electronic apparatus for musical instruments according to a second embodiment of the present disclosure;

FIG. 12 is a front view of the main part of the first component of the electronic apparatus for musical instruments according to the second embodiment of the present disclosure with a movable element main body indicated by a chain double-dashed line; and

FIG. 13 is a front view of the main part of the first component of the electronic apparatus for musical instruments according to the second embodiment of the present disclosure which shows a state in which the movable element has moved, with the movable element main body indicated by a two-dot chain line.

### DESCRIPTION OF THE EMBODIMENTS

### First Embodiment

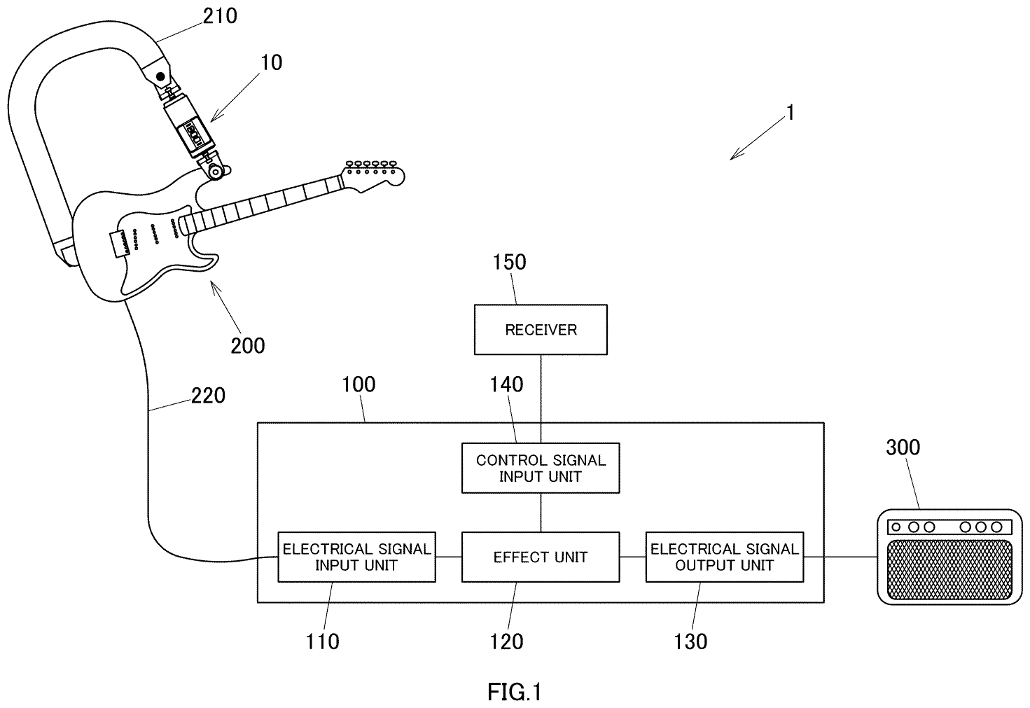

Hereinafter, referring to drawings, an embodiment of the present disclosure will be described. A playing system 1 shown in FIG. 1 includes an effector apparatus 100, an electric guitar 200, which is an electric musical instrument (that is, a musical instrument), and a guitar amplifier 300. The electronic apparatus for musical instruments (hereinafter simply referred to as the electronic apparatus) 10 according to the embodiment of the present disclosure is attached between a guitar strap 210, which is slung over one shoulder of a player to suspend the electric guitar 200, and the electric guitar 200. Musical sound can be controlled by the electronic apparatus 10.

The electric guitar 200 is connected to the effector apparatus 100 by way of a guitar cable 220. The effector apparatus 100 has an effect unit 120 which is connected individually with an electrical signal input unit 110, an electrical signal output unit 130 and a control signal input unit 140. The electrical signal input unit 110 is connected to the guitar cable 220, whereby an electrical signal (a sound signal) from the electric guitar 200 is input into the electrical signal input unit 110. Then, the effect unit 120 applies various types of effects as of a wow, a distortion and the like to the electrical signal input thereinto from the electrical signal input unit 110, and then, the resulting electrical signal is output by way of the electrical signal output unit 130. The electrical signal output unit 130 is connected to the guitar amplifier 300. The electrical signal output from the electrical signal output unit 130 is eventually emitted from the guitar amplifier 300 in the form of sound.

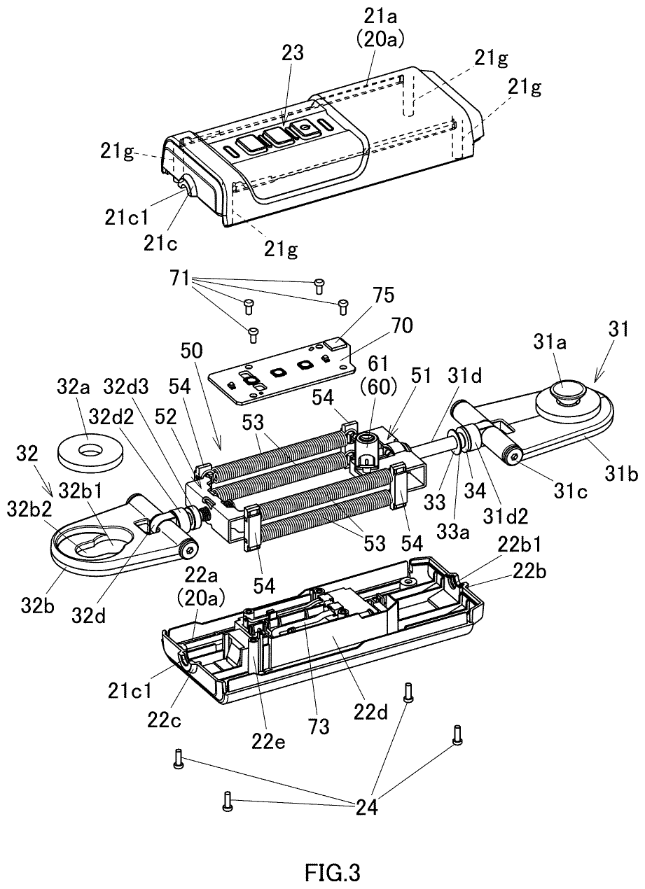

The effect unit 120 applies a specific effect to the electrical signal input thereinto from the electrical signal input unit 110 based on a control signal from the control signal input unit 140. For application of such an effect, the extent of effects as of a wow, a distortion and the like is arbitrarily controlled by the electronic apparatus 10. The control signal input unit 140 is connected to a receiver 150 (an external device). The receiver 150 can receive an output from a communication unit 75 (refer to FIG. 3) of the electronic apparatus 10.

In the electronic apparatus 10, with the strap 210 slung over the shoulder of the player to suspend the electric guitar 200, when the player of the electric guitar 200 presses the electric guitar 200 downwards to apply a tension to the strap 210 while the player is playing the electric guitar 200, a rotational shaft 41 of a rotation detection device 40, which will be described later, rotates in accordance with the tension applied to the strap 210. A rotation amount of this rotational shaft 41 is detected by the rotation detection device 40 and is sent from the electronic apparatus 10 to the receiver 150 as a control signal, whereby the effector apparatus 100 can be controlled. That is, the communication unit 75 sends the detection value detected by the rotation detection device 40, which will be described later, to the receiver 150, which constitutes the exterior equipment, whereby a sound to which an effect is applied in the effector apparatus 100 is produced.

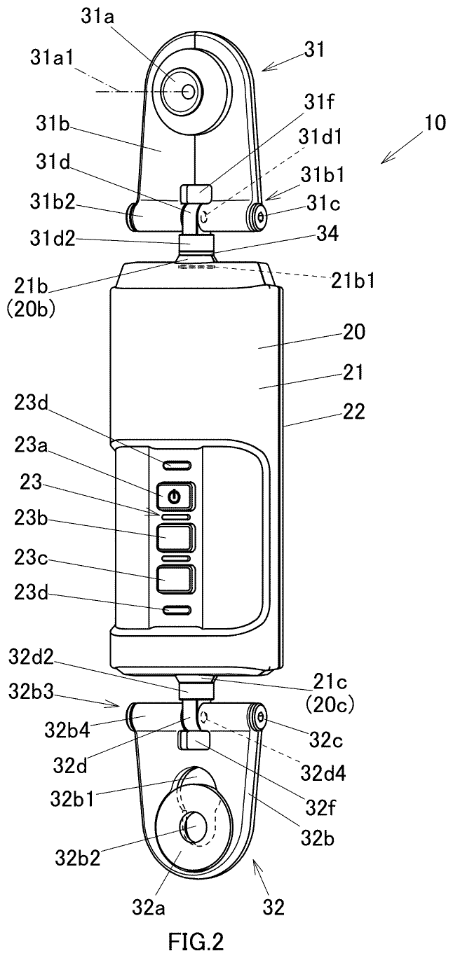

As shown in FIG. 2, the electronic apparatus 10 has a substantially rectangular case 20. The case 20 has a front case 21 including a controller 23 including, in turn, a power button 23a, two control buttons 23b, 23c and multiple LEDs 23d configured to indicate a control state and a back case 22 which constitutes an opposite side of the case 20. The front case 21 and the back case 22 are combined and screwed together with four screws 24 (refer to FIG. 3). These four screws 24 are screwed individually from a back side of the back case 22 via threaded holes in bosses 22g, which are provided substantially in four corners in an interior of the back case 22, into four corresponding internally threaded bosses 21g, which are provided in an interior of the front case 21 in such a manner as to correspond to the bosses 22g. The electronic apparatus 10 includes a first component 31 and a second component 32 which are provided in such a manner as to protrude from the case 20, and the first component 31 is coupled to the strap 210, while the second component 32 is coupled to the musical instrument (the electric guitar 200). Here, in the following description, a side or end of the case 20 to which the first component 31 is coupled denotes an upper side or up, and a side or end to which the second component 32 is coupled denotes a lower side or down. In addition, when looking at the electronic apparatus 10 from a front side thereof, a left side of the electronic apparatus 10 denotes a left side or leftwards, and a right side thereof denotes a right side or rightwards.

The first component 31 includes a plate 31b having a strap pin 31a and formed into a substantially trapezoidal shape in which a distal end portion of the plate 31b is formed substantially into an arc shape. The strap pin 31a is inserted in a slit provided at one end of the strap 210, which is a known musical instrument strap, so as to be coupled thereto. A shaft hole 31b1 is provided at a lower end of the plate 31b in such a manner as to penetrate the lower end in a left-right direction, and a pin 31c, which is long in the left-right direction, is inserted into the shaft hole 31b1 in such a manner as to extend all through the shaft hole 31b1. The pin 31c is passed through a shaft hole 31d1 formed in a distal end portion of a first shaft element 31d, which protrudes upwards from the case 20. A cylindrical section 31b2, which is provided at the lower end of the plate 31b and which makes up the shaft hole 31b1, is cut out in a central portion thereof, and a distal end portion of the first shaft element 31d is inserted thereinto. A substantially rectangular opening 31f is provided in the plate 31b above the portion where the distal end portion of the first shaft element 31d is inserted. The plate 31b of the first component 31 is provided in such a manner as to be rotatable about an axial center of the pin 31c.

The second component 32 includes a plate 32b having an annular elastic element 32a and formed into a substantially trapezoidal shape in which a distal end portion of the plate 32b is formed substantially into an arc shape. The plate 32b includes a large hole section 32b1 and a small hole section 32b2 which communicate with the large hole section 32b1 (also, refer to FIG. 3). The second component 32 is connected to a strap pin (not shown) provided on the musical instrument. The strap pin on the musical instrument is first inserted into the large hole section 32b1 and is then moved into the small hole section 32b2, whereafter the elastic element 32a is fitted on the strap pin, whereby the strap pin is connected to the second component 32.

A shaft hole 32b3 is provided at an upper end of the plate 32b in such a manner as to penetrate the lower end in the left-right direction, and a pin 32c, which is long in the left-right direction, is inserted into the shaft hole 32b3 in such a manner as to extend all through the shaft hole 32b3. A cylindrical section 32b4, which is provided at the upper end of the plate 32b and which makes up the shaft hole 32b3, is cut out in a central portion thereof, and a distal end portion of a second shaft element 32d is inserted thereinto. A substantially rectangular opening 32f is provided in the plate 32b above the portion where the distal end portion of the second shaft element 32d is inserted. The pin 32c is inserted into a shaft hole 32d4 at a distal end portion of the second shaft element 32d which protrudes downwards from the case 20. The plate 32b of the second component 32 is provided in such a manner as to be rotatable about an axial center of the pin 32c.

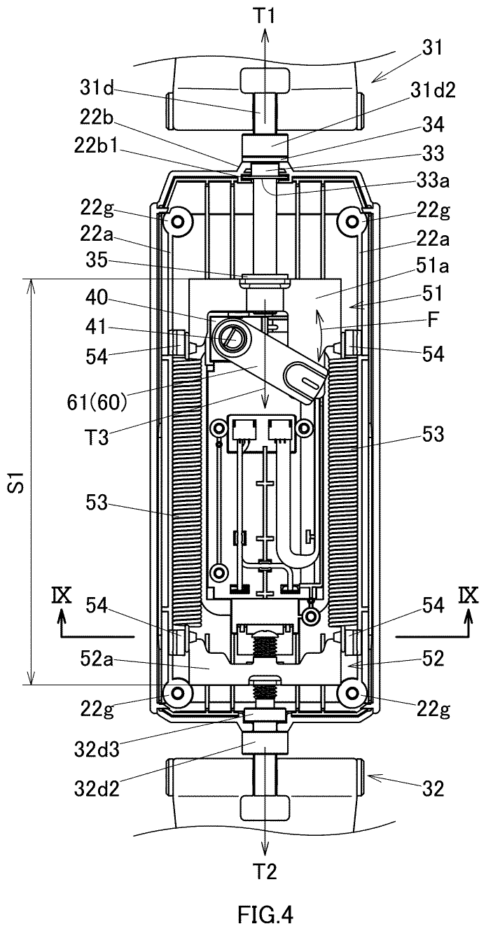

As shown in FIGS. 3, 4, the first shaft element 31d of the first component 31 has a shaft shape and includes a large diameter section 31d2 which is provided in the vicinity of the shaft hole 31d1 at an upper end thereof. A substantially cylindrical bush 33 is provided below the large diameter section 31d2 of the first shaft element 31d. The bush 33 includes a flange 33a which is provided on a lower side of the bush 33 (also, refer to FIG. 4). Here, a stationary section 20b is provided at an upper end of the case 20, and this stationary section 20b includes an opening through which the first shaft element 31d is passed and protrudes substantially into a shape of a frustum of circular cone (refer to FIG. 2). The stationary section 20b is made up of a stationary section 21b formed on the front case 21 and a stationary section 22b formed on the back case 22. Grooves 21b1 (refer to FIG. 2), 22b1 are provided on the stationary sections 21b, 22b, respectively.

The flange 33a of the bush 33 is fitted in the grooves 21b1, 22b1 of the stationary section 20b of the case 20. As a result, the bush 33 is fixed in place in such a manner as to be held between the front case 21 and the back case 22. The first shaft element 31d is supported by the bush 33 in such a manner as to slide in an up-down direction and around an axis of the first shaft element 31d. Additionally, a damper 34, which is made of an elastic element, is provided between the bush 33 and the large diameter section 31d2 of the first shaft element 31d.

The second shaft element 32d of the second component 31 has a shaft shape and includes a large diameter section 32d2 which is provided in the vicinity of the shaft hole 32d4 at a lower end thereof. As shown in FIG. 3, a stationary large diameter section 32d3 is provided on the second shaft element 32d in a position lying above the large diameter section 32d2. A stationary section 20c is provided at a lower end of the case 20, and this stationary section 20c includes an opening through which the second shaft element 32d is passed and protrudes substantially into a shape of a frustum of circular cone (refer to FIG. 2). The stationary section 20c (stationary sections 21c, 22c) is disposed in such a manner that a top surface portion thereof is held between the large diameter section 32d2 and the stationary large diameter section 32d3. As a result, the large diameter section 32d2 and the stationary large diameter section 32d3, that is, the second shaft element 32d is supported in such a manner as to be fixed or stationary in the up-down direction and the left-right direction and to rotate about an axis of the second shaft element 32d relative to the case 20.

A generator 60 is accommodated in the case 20. This generator 60 is configured to generate a rotational movement in accordance with a distance between the first component 31 and the second component 32 which is configured to change based on a tension applied to the first component 31 and the second component 32. In addition, a slider 50 is accommodated in the case 20. This slider 50 is configured to change the distance between the first component 31 and the second component 32 based on a tension. The slider 50 includes a movable element 51 coupled to the first component 31 in such a manner as to be movable relative to the case 20 and a stationary element 52 coupled to the second component 32 in such a manner as to be fixed to the case 20. Here, a movable element can also be provided on the second component 32 in place of the stationary element 52.

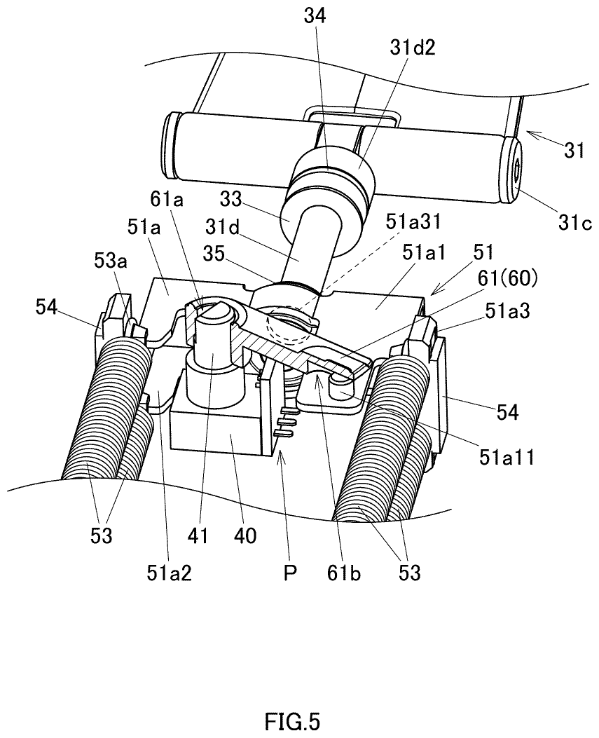

Specifically speaking, as shown in FIG. 4, the movable element 51 of the slider 50 includes a movable element main body 51a. When viewed in the left-right direction, the movable element main body 51a is made into a substantially U-shaped metallic sheet of which an open side is directed downwards. As shown in FIG. 5, the movable element main body 51a includes a front plate 51a1 on a front side, a back plate 51a2 on a back side and a bottom plate 51a3 which connects an upper side of the front plate 51a1 and an upper side of the back plate 51a2 together. An open hole 51a31 is provided in a substantially central portion of the bottom plate 51a3, so that the first shaft element 31d is passed therethrough. A damper 35, which is made of an elastic element, is provided on an upper surface of the bottom plate 51a3 in a position which corresponds to the open hole 51a31.

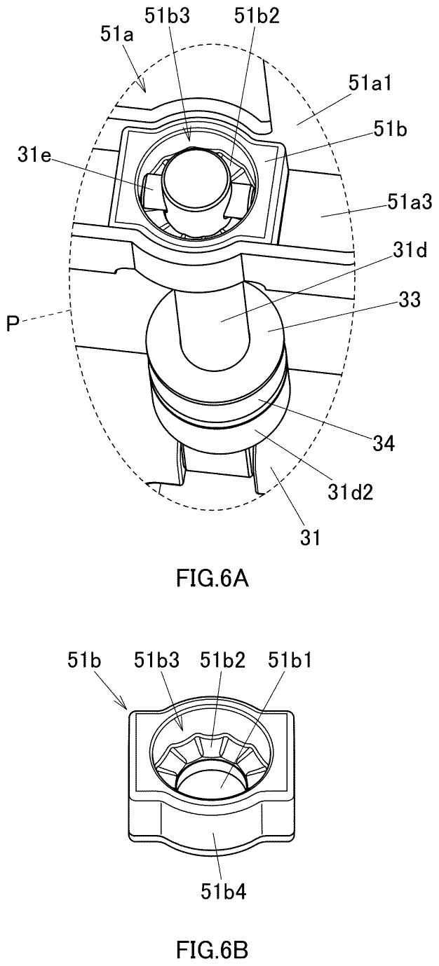

As shown in FIG. 6A, which is a view as viewed in a direction P in FIG. 5, an angle controller 51b is provided substantially at a center in the left-right direction in an interior defined by the front plate 51a1, the back plate 51a2 and the bottom plate 51a3 of the movable element main body 51a. As shown in FIG. 6B, the angle controller 51b includes a penetrating opening 51b1 and a circular concave section 51b3 which is larger than the opening 51b1. The angle controller 51b includes multiple grooves 51b2 which are provided radially along the opening 51b1 on a side of the circular concave section 51b3 which lies to face the opening 51b1. The angle controller 51b includes protuberant sections 51b4 on opposite sides thereof and is fixed to the movable element main body 51a with the circular concave section 51b3 directed downwards in such a manner that the front plate 51a1 and the back plate 51a2 are joined to the two protuberant sections 51b4 as by crimping or swaging. The open hole 51a31 in the bottom plate 51a3 and the opening 51b1 in the angle controller 51b are made to be coaxial with each other, so that the first shaft element 31d is passed therethrough.

As shown in FIG. 6A, a pin 31e is provided at a distal end of the first shaft element 31d in such a manner as to extend at right angles to an axis direction of the first shaft element 31d (in other words, at right angles to a tension T1 applied to the first component 31).

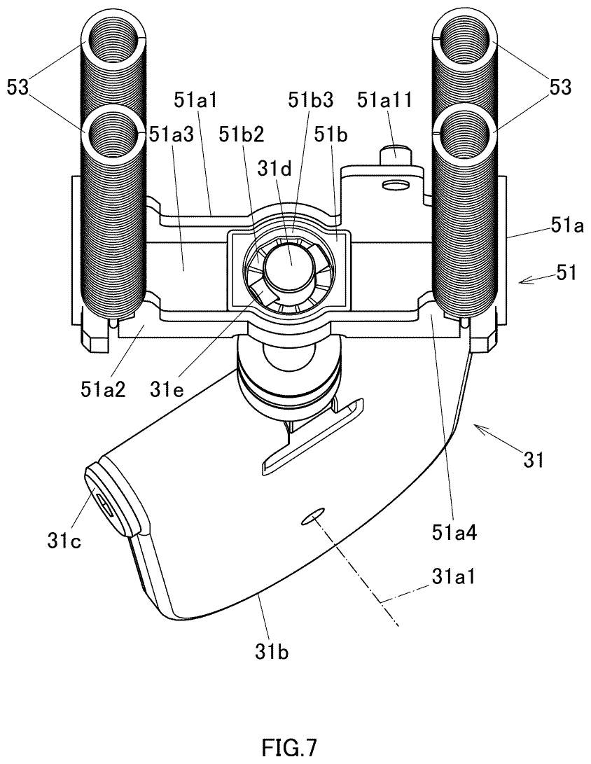

Each groove 51b2 of the angle controller 51b has a concavely recessed arc shape of which a radius of curvature is similar to that of the cylindrical pin 31e so that the cylindrical pin 31e can be brought into engagement with the groove 51b2. Portions of the pin 31e which protrude from the first shaft element 31d brought are into engagement with the corresponding grooves 51b2, whereby the first component 31 and the movable element 51 (the movable element main body 51a) are fixed relatively at least when an upward tension is applied to the first component 31. As shown in FIG. 7, when the grooves 51b2 with which the pin 31e is brought into engagement are changed over, the orientation of the case 20, that is, the front surface of the case 20 (the orientation of the controller 23) relative to an axis 31a1 of the strap pin 31a of the first component 31 can be controlled. Here, an angle control mechanism, consisting of the angle controller 51b and the pin 31e, can also be provided on the second component 32.

As shown in FIG. 5, a pin 51a11 is provided on the front plate 51a1 of the movable element main body 51a in such a manner as to be erected therefrom. On the other hand, the rotation detection device 40 is provided on the back case 22 of the case 20. The rotation detection device 40 is made into a rotary volume including the rotational shaft 41 of which a surface is partially cut to be given a D-shape. Here, the rotation detection device 40 can also take the form of other rotation detection devices 40 such as a rotary encoder, rotation detection equipment for detecting a rotational position of a rotational body and the like in addition to the rotary volume. That is, the rotation detection device 40 need only be equipment for detecting a rotation amount of a rotational movement generated by the generator 60. Then, the rotational shaft 41 of the rotation detection device 40 and the pin 51a11 of the movable element main body 51a are coupled together by the generator 60. In the present embodiment, the rotational shaft 41 and the pin 51a11 are coupled together by a lever 61 of the generator 60. The lever 61 is provided as a long component. A D-shaped hole 61a is provided in one end of the lever 61. The D-shaped rotational shaft 41 is brought into engagement with the hole 61a. The lever 61 is fixed to the rotational shaft 41. A groove 61b is provided in the other end of the lever 61. The groove 61b extends in a longitudinal direction of the lever 61 and is opened in a distal end or the other end of the lever 61. The pin 51a11 is brought into sliding engagement with the groove 61b. When the pin 51a11 slides within the groove 61b as the movable element 51 moves, the lever 61 rotates (oscillates) as indicated by an arrow F in FIG. 4. Here, a mechanism other than the lever 61, for example, a rack-and-pinion mechanism can also be adopted, provided that the mechanism can generate a rotational movement in accordance with a changed distance. A smaller rotation detection device than a rectilinear movement detection device such as a slide volume for detecting a change in a rectilinear movement amount can be used by generating a rotational movement in accordance with a change in the distance between the first component 31 and the second component 32 by the slider 50, and hence, the electronic apparatus 10 can be made smaller in size.

A rotation amount of the lever 61 is set to fall within the range of an electrical effective rotation angle of the rotation detection device 40. That is, the lever 61 is given a shape which can cover the tolerance of the electrical effective rotation angle of the rotation detection device 40. Specifically speaking, for example, when the electrical effective rotation angle of the rotation detection device 40 is 60°±5°, the rotation amount of the lever 61 (the swing angle of the lever 61) is set at 66°. In this case, the movement amount of the pin 51a11 (that is, the stroke of the movable element 51) is set at 20 mm.

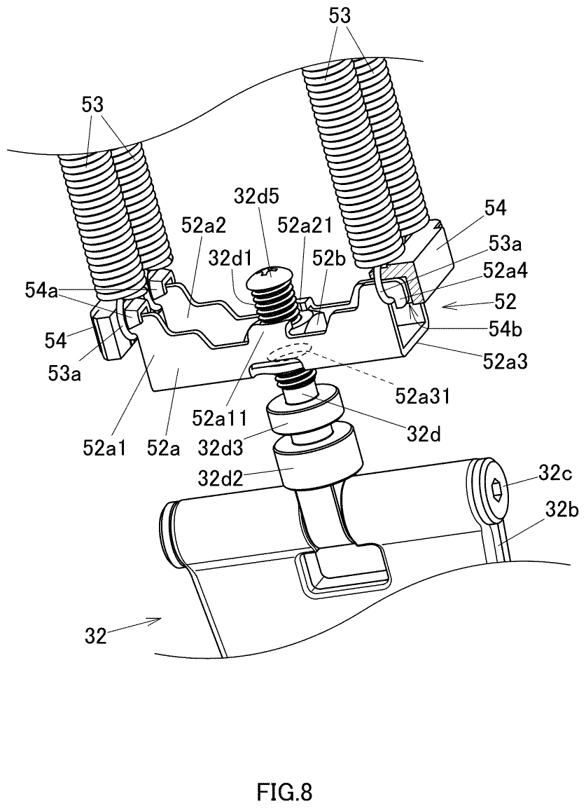

As shown in FIG. 8, a stationary element main body 52a is provided on the stationary element 52 of the slider 50. When viewed in the left-right direction, the stationary element main body 52a is made into a substantially U-shaped metallic sheet of which an open side is directed upwards. The stationary element main body 52a includes a front plate 52a1 on a front side, a back plate 52a2 on a back side and a bottom plate 52a3 which connects a lower side of the back plate 52a1 and a lower side of the back plate 52a2 together. An open hole 52a31 is provided in a substantially central portion of the bottom plate 52a3, so that the second shaft element 32d is passed therethrough.

A nut 52b is provided substantially at a center in the left-right direction in an interior defined by the front plate 52a1, the back plate 52a2 and the bottom plate 52a3 of the stationary element main body 52a. The nut 52b includes stationary bend sections 52a11, 52a21 which are formed as a result of substantially central portions of the front plate 52a1 and the back plate 52a21 being partially bent, so that the nut 52b is fixed to the stationary element main body 52a. An externally threaded section 32d1 is provided at a distal end portion of the second shaft element 32d for thread engagement with the nut 52b.

When the second shaft element 32d (that is, the second component 32) is rotated, the stationary element 52 (the stationary element main body 52a) moves relative to the case 20 as a result of the thread engagement between the nut 52b and the externally threaded section 32d1, thereby making it possible to control the distance between the movable element 51 and the stationary element 52 (the distance between the movable element 51 and the stationary element 52 in a steady state). For example, a distance S1 in FIG. 4 changes. Here, a stopper 32d5 is provided at a distal end of the second shaft element 32d coaxially with the second shaft element 32d. The stopper 32d5 has a diameter which is set larger than a diameter of the open hole 52a31, and hence, the externally threaded section 32d1 (the second shaft element 32d) can be restrained from escaping from the nut 52b. In this embodiment, a screw is used for the stopper 32d5. Here, the combination of the externally threaded section 32d1 and the nut 52b can also be provided on the movable element 51.

Four coil springs 53 (expandable elements) are provided on the movable element 51 and the stationary element 52 in such a manner as to extend therebetween. The coil springs 53, which are the expandable elements, are provided in such a manner as to expand or contract in accordance with a tension applied to the first component 31 and the second component 32. The four coil springs 53 are arranged such that two coil springs 53 are disposed individually on the left and right sides of the slider 50 with the two coil springs aligned side by side in a front-back direction. A locking ring 53a is provided individually at an upper end and a lower end of each coil spring 53. On the other hand, hook-shaped locking claws 51a4, 52a4 (refer to FIGS. 7 and 8) are provided on a left and right sides of the movable element main body 51a and the stationary element main body 52a, respectively. Specifically speaking, two hook-shaped locking claws 51a4, 52a4 are disposed individually on the left and right sides of the movable element main body 51a and the stationary element main body 52a, respectively, with the two hook-shaped locking claws aligned side by side in the front-back direction. The respective locking rings 53a of the coil springs 53 are hooked individually on the corresponding locking claws 51a4, 52a4.

The four coil springs 53 are disposed in an expanded state. As a result, the movable element 51 and the stationary element 52 are biased by the four coil springs 53 in a direction in which the relative distance between the movable element 51 and the stationary element 52 is reduced or the movable element 51 and the second element 52 are caused to move to each other. In other words, the movable element 51 (the first component 31) is biased towards the stationary element 52 (the second component 32) which is fixed to the case 20 by the four coil springs 53.

A sliding element 54 is provided individually on a left and right sides of each of the movable element 51 and the stationary element 52. One sliding element 54 is disposed individually on the left and right sides of the movable element 51, and one sliding element 54 is disposed individually on the left and right sides of the stationary element 52. As shown in FIG. 8, the sliding element 54 has a rectangular shape which is long in the front-back direction and includes two engagement protruding sections 54a protruding inward and two engagement recessed sections 54b which are provided in such a manner as to correspond individually to the two engagement protruding sections 54a. The engagement protruding section 54a has substantially a U-shape. The engagement recessed section 54b is formed into a recess which communicate with a substantially U-shaped opening of the engagement protruding section 54a. The engagement protruding sections 54a are inserted into the corresponding locking rings 53a, 53b of the coil springs 53 for engagement therewith. The respective locking claws 51a4, 52a4 of the movable element main body 51a and the stationary element main body 52a are inserted into the corresponding engagement recessed sections 54b.

The sliding elements 54 integrate into the movable element 51 and the stationary element as a result of the engagement protruding sections 54a being inserted into the locking rings 53a, 53b of the coil springs 53 and the locking claws 51a4, 52a4 being inserted into the engagement recessed sections 54b.

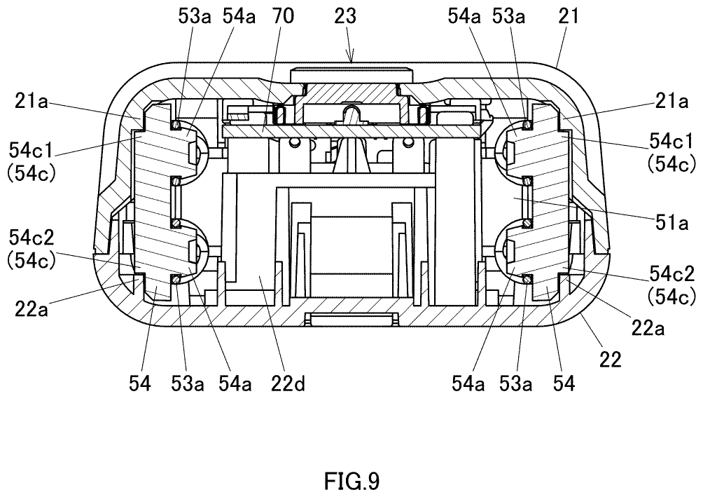

Here, as shown in FIG. 9, back sliding rails 22a (also, refer to FIGS. 3 and 4) are provided on the back case 22 as a rectangular protrusion which is long in the up-down direction. Front sliding rails 21a (also, refer to FIG. 3) are provided on the front case 21 in positions corresponding to the back sliding rails 22g while being formed long in the up-down direction and into a step-like configuration as shown in a sectional view in FIG. 9. The back sliding rails 22a each connect with the two upper and lower bosses 22g. Similarly, the front sliding rails 21a each connect with the two upper and lower internally threaded bosses 21g. Then, the sliding elements 54 each include front and back step-like sliding sections 54c (a front sliding section 54c1, a back sliding section 54c2). The front sliding section 54c1 is brought into engagement with the front sliding rail 21a, and the back sliding section 54c2 is brought into engagement with the back sliding rail 22a. The sliding elements 54 are guided in the up-down direction by the sliding rails 20a which are made up of the front sliding rails 21a and the back sliding rails 22a.

The movable element 51 is moved by the sliding elements 54 being guided by the sliding rails 20a. Here, the stationary element 52 is moved relative to the case 20 when tensions T1, T2, which will be described later, are controlled, and at this time, the sliding elements 54 of the stationary element 52 are guided by the sliding rails 20a.

As shown in FIG. 3, a battery box 22d is provided on the back case 22 at a portion defined between the movable element 51 and the stationary element 52 and between the left and right coil springs 53. An electronic circuit board 70 is provided on a front side of the battery box 22d. The electronic circuit board 70 is screwed fixedly onto the back case 22 with screws 71 which are screwed individually into four substantially cylindrical bosses 22e which are erected inside the back case 22. Additionally, a wiring 73 is provided on the front side of the battery box 22d to supply electric power to the rotation detection device 40 and the electronic circuit board 70.

As shown in FIG. 4, the electronic apparatus 10 attached to the strap 210 of the electric guitar 200 is such that when the strap 210 is slung over the shoulder of the player, tensions T1, T2 are applied to the first component 31 and the second component 32, respectively. Here, since the second shaft element 32d is fixed to the case 20 in the up-down direction (the axis direction), the second component 32 and the stationary element 52 are fixed to the case 20 in the up-down direction. On the other hand, since the first component 31 and the movable element 51 are provided movable in the up-down direction relative to the case 20, the first component 31 and the movable element 51 move upwards to a position where a balance is kept between a biasing force T3 of the four coil springs 53 and the tension T1, resulting in a state in which the electric guitar 200 is suspended from the shoulder of the player (that is, the steady state).

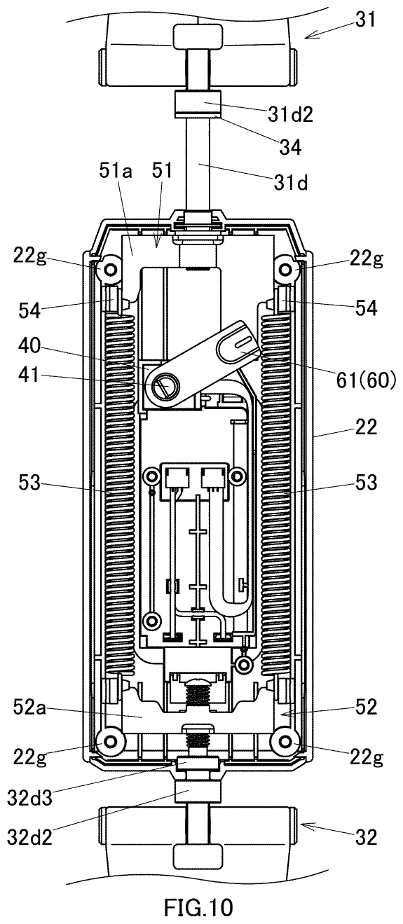

When the player presses the electric guitar 200 downwards, the tensions T1, T2 are increased, and the tensions T1, T2 are then applied to the first component 31 and the second component 32, respectively, whereby the movable element 51 (the first component 31) moves upwards relative to the case 20 against the elastic force (the biasing force T3) of the four coil springs 53. Then, as shown in FIG. 10, the lever 61 oscillates around the rotational shaft 41 of the rotation detection device 40 (specifically speaking, in a counterclockwise direction in FIG. 10). The rotation detection device 40 sends a rotation amount at which the rotational shaft 41 has rotated to the receiver 150 by way of the communication unit 75. When receiving the rotation amount detected by the rotation detection device 40, the control signal input unit 140 causes the effect unit 120 to apply an effect in accordance with this rotation amount.

The player sees the case 20 moving downwards together with the electric guitar 200 when the player presses the electric guitar 200 downwards, and when the player reduces or releases the force with which the player is pressing the electric guitar 200 downwards, the player sees the case 200 moving upwards. As a result, the player can grasp the magnitude of application of the effect through the movement amount of the case 20 (the movement of the case 20 which moves relative to the first component 31).

The tensions T1, T2 applied to the first component 31 and the second component 32 respectively can be controlled by moving the position of the stationary element 52 relative to the case 20. This control can be performed by rotating the second component 32 (that is, the second shaft element 32d) so as to move the stationary element 52 in the up-down direction relative to the case 20 through the threading engagement between the nut 52b and the externally threaded screw section 32d1. When the stationary element 52 is moved upwards (the stationary element 52 is moved in a direction in which the distance between the movable element 51 and the stationary element 52 is reduced), the expansion of the coil springs 53 is mitigated, whereby the tensions T1, T2 applied to the first component 31 and the second component 32 respectively can be reduced. As a result, the player can press the electric guitar 200 downwards with a lighter force. On the contrary, when the stationary element 52 is moved downwards (the stationary element 52 is moved in a direction in which the distance between the movable element 51 and the stationary element 52 is increased), the expansion of the coil springs 53 is increased, whereby the tensions T1, T2 applied to the first component 31 and the second component 32 respectively can be increased. As a result, the coil springs 53 can be prevented from being expanded due to the own weight of the electric guitar 200 by controlling the tensions T1, T2 applied to the first component 31 and the second component 32 respectively.

### Second Embodiment

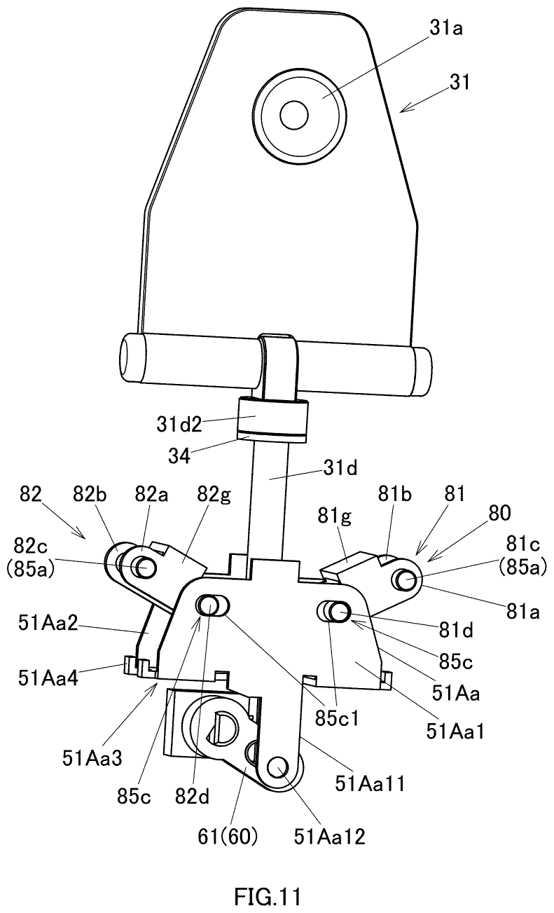

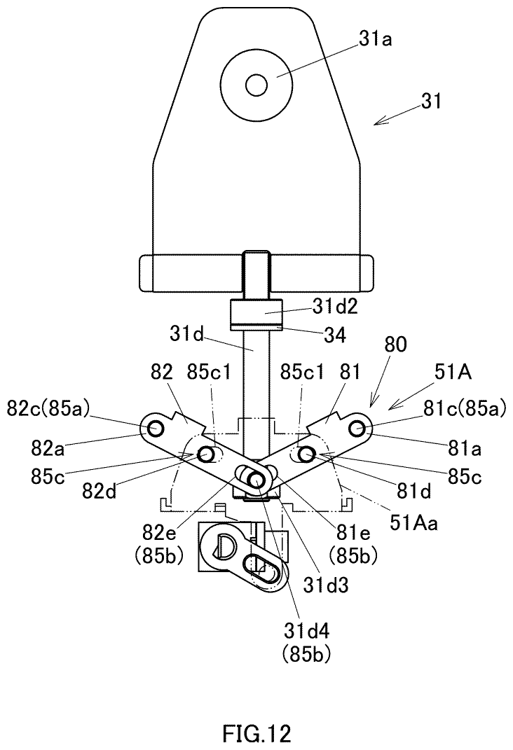

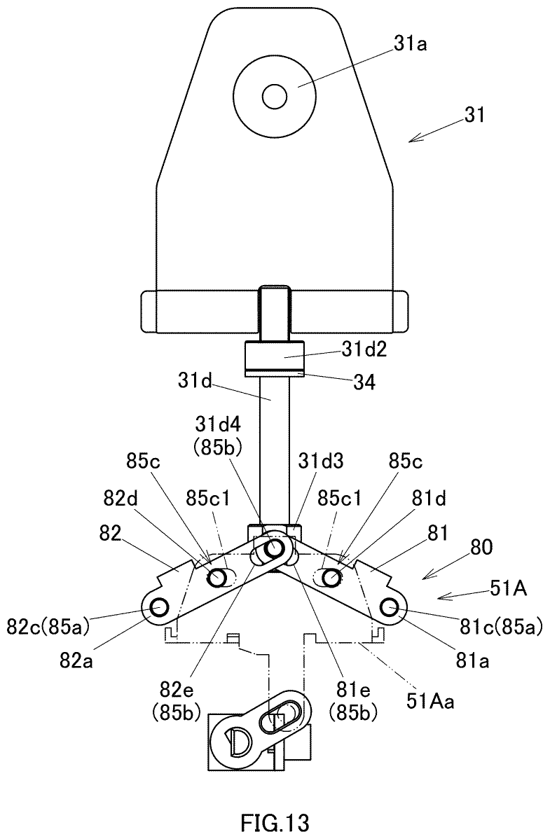

Referring to FIGS. 11 to 13, a second embodiment of the present disclosure will be described. An electronic apparatus of the present embodiment differs from the electronic apparatus 10 of the first embodiment in that a first shaft element 31d of a first component 31 is coupled to a movable element 51A via links (a first link 81, a second link 82) of a link mechanism 80 in place of the configuration of the first embodiment in which the first shaft element 31d of the first component 31 is coupled directly to the movable element 51. Consequently, in FIGS. 11 to 13, the first component 31, the movable element 51A, a generator 60 and a rotation detection device 40 will mainly be described. In the following description, like reference numerals or symbols to those of the first embodiment will be given to elements and sections like to those of the first embodiment, and the description thereof will be omitted or simplified.

A movable element main body 51Aa of the movable element 51 is made up of a substantially U-shaped metallic sheet in a side view. The movable element main body 51Aa includes a front plate 51Aa1, a back plate 51Aa2 and a bottom plate 51Aa3. The front plate 51Aa1 includes a lever connection section 51Aa11 which extends downwards into a tongue-like shape. A pin 51Aa12 is provided on the lever connection section 51Aa11, so that the lever connection section 51Aa11 is connected to the other end of a lever 61. In the present embodiment, the other end of the lever 61 as the generator 60 is formed into an elongated hole. Additionally, two locking claws 51Aa4 are provided individually on a left and right end portions of the bottom plate 51Aa3.

A connection element 31d3 is provided fixedly at a distal end of the first shaft element 31d of the first component 31. A pin 31d4 is provided on the connection element 31d3 in such a manner that an axis of the pin 31d4 is directed in a front-back direction.

The link mechanism 80 includes the first link 81 and the second link 82. The first link 81 and the second link 82 are formed substantially symmetrical. The first link 81 includes a front first link plate 81a on a front side and a back first link plate 81b on a back side thereof. Similarly, the second link 82 includes a front second link plate 82a on a front side and a back second link plate 82b on a back side thereof. A distance between the front second link plate 82a and the back second link plate 82b is set larger than a distance between the front first link plate 81a and the back first link plate 81b.

The front first link plate 81a and the back first link plate 81b, and the front second link plate 82a and the back second link plate 82b are connected together respectively by connection plates 81g, 82g which are provided at upper portions of the first link 81 and the second link 82, respectively, as a thick plate, stationary fulcrum pins 81c, 82c, which will be described later, and movable element coupling pins 81d, 82d.

The stationary fulcrum pins 81c, 82c, which are stationary fulcrums 85a, are provided at one ends of the first link 81 and the second link 82, respectively, while being fixed to the first link 81 and the second link 82, respectively. The stationary fulcrum pins 81c, 82c are pivotally supported on a case 20 (refer to FIGS. 1, 3) in such a manner as to rotate around axes thereof. Elongated holes 81e, 82e are provided in the other ends of the first link 81 and the second link 82, respectively. The pin 31d4 of the connection element 31d3 is passed through the elongated holes 81e, 82e. The pin 31d4 is connected to the first shaft element 31d, that is, the first component 31 via the connection element 31d3. The other ends of the first link 81 and the second link 82 are made into a first component coupling fulcrum 85b which is made up of the elongated holes 81e, 82e and the pin 31d4.

The first link 81 and the second link 82 include movable element coupling pins 81d, 82d, respectively, which are provided between the stationary fulcrum pins 81c, 82c and the elongated holes 81e, 82e, respectively. The movable element coupling pin 81d is provided fixedly on the first link 81 in such a manner as to penetrate the front first link plate 81a and the back first link plate 81b. Similarly, the movable element coupling pin 82d is provided fixedly on the second link 82 in such a manner as to penetrate the front second link plate 82a and the back second link plate 82b.

The movable element coupling pins 81d, 82d are inserted into elongated holes 85c1 which are provided in the front plate 51Aa1 and the back plate 51Aa2 of the movable element 51A in such a manner as to correspond to the movable element coupling pins 81d, 82d. The elongated holes 85c1 are provided long in a left-right direction. Portions of the first link 81 and the second link 82 which are defined between the stationary fulcrum 85a and the first component coupling fulcrum 85b are individually made into movable element coupling fulcrums 85c which are made up of the movable element coupling pins 81d, 82d and the elongated holes 85c1.

When the first component 31 moves upwards, the first component coupling fulcrum 85b moves upwards, whereby the first link 81 and the second link 82 oscillate around the stationary fulcrums 85a. The first link 81 oscillates in a clockwise direction, while the second link 82 oscillates in the counterclockwise direction. Then, the movable element coupling fulcrums 85c move upwards, whereby the movable element 51A also moves upwards. As a result of the upward movement of the movable element 51A, the lever 61 also oscillates via the lever connection element 51Aa11 and the pin 51Aa12. The lever 61 oscillates in the counterclockwise direction. In the present embodiment, a distance from the stationary fulcrum 85a to the first component coupling fulcrum 85b and a distance from the stationary fulcrum 85a to the movable element coupling fulcrum 85c are set so that a movement amount of the movable element 51A becomes a half of a movement amount of the first component 31.

Here, the electronic apparatus for musical instruments according to the embodiment of the present disclosure will be described in comparison with the electronic apparatus for musical instruments disclosed in Japanese Patent Application Laid-Open No. 59-60692. Generally, the strap of an instrument does not visibly stretch significantly even when a tension is applied. Therefore, it is difficult for the player to recognize the force applied to the strap as a physical change, making it challenging to control the desired musical tone.

To address this issue, the electronic apparatus 10 according to the embodiment of the present disclosure includes a first component 31 configured to be coupled to the strap 210, the second component 32 configured to be coupled to the electric guitar 200, which is the musical instrument, the generator 60 configured to generate a rotational movement in accordance with a distance between the first component 31 and the second component 32 which changes based on a tension applied to the first component 31 and/or the second component 32, and the rotation detection device 40 configured to detect a rotation amount of the rotational movement generated by the generator 60.

As a result, for example, the first component 31 and the second component 32 move away from each other in accordance with a tension and/or tensions applied to the first component 31 and/or the second component 32. Then, the generator 60 generates a rotational movement in accordance with a change in the distance between the first component 31 and the second component 32 (the distance from the first component 31 to the second component 32, the distance from the second component 32 to the first component 31, or the relative distance between the first component 31 and the second component 32). The rotation detection device 40 then detects a movement amount of the generated rotational movement. As a result, the rotation amount detected by the rotation detection device 40 is sent to the receiver 150 as a control signal to thereby control the effector apparatus 100. Thus, the force applied to the strap can easily be recognized as the physical change to thereby control musical sound. In addition, a smaller rotation detection device than a rectilinear movement detection device such a slide volume can be used by generating a rotational movement in accordance with a change in the distance between the first component 31 and the second component 32, whereby the electronic apparatus 10 can be made smaller in size.

The electronic apparatus 10 includes the slider 50 configured to change the distance between the first component 31 and the second component 32 based on an applied tension. As a result, the distance between the first component 31 and the second component 32 can be changed in accordance with an applied tension by the sliding mechanism of the simple configuration.

The slider 50 includes the coil springs 53, which are the expandable elements configured to expand or contract in accordance with tensions applied to the first component 31 and the second component 32. Specifically speaking, the coil springs 53 are provided between the movable element 51 and the stationary element 52. Tensions applied to the first component 31 and the second component 32 can also be generated, for example, by making the first component 31 and the second component 32 move to slide with predetermined resistances applied individually to the first component 31 and the second component 32, however, the first component 31 and the second component 32 can be caused to restore easily while generating tensions on the first component 31 and the second component 32 with the simple configuration by employing the coil springs 53, which are the expandable elements. Here, the expandable elements may be other expandable elements such as elastic elements of silicone rubber, elastomer or the like.

The electronic apparatus 10 includes the movable element 51 coupled to the first component 31 and configured to move in accordance with a tension applied to the first component 31, and the generator 60 includes the lever 61 which couples the movable element 51 and the rotation detection device 40 together. Then, the generator 60 generates a rotational movement by rotating the lever 61 in accordance with a movement of the movable element 51. As a result, the small rotation detection device for detecting a rotation amount of the rotational movement can be used, thereby making it possible to make the electronic apparatus 10 smaller in size.

The movable element 51 includes the pin 51a11, and the lever 61 includes the groove 61b with which the pin 51a11 is brought into sliding engagement, whereby the lever 61 rotates as a result of the pin 51a11 sliding within the groove 61b as the movable element 51 moves. As a result, the rotational movement can be generated smoothly with the simple configuration.

The electronic apparatus 10 includes the stationary element 52 coupled to the second component 32 and configured not to move in accordance with a tension. Although the second component 32 can also be configured to be coupled to a movable element, one of the first component 31 and the second component 32 is coupled to the movable element, and the other is coupled to the stationary element, whereby the movement of the first component 31 coupled to the movable element or the second component 32 can visually be recognized more easily.

The first component 31 is coupled to the movable element 51 via the link mechanism 80 including the links (the first link 81, the second link 82), and the links each include the stationary fulcrum 85a provided at one end, the first component coupling fulcrum 85b provided at the other end in such a manner as to be coupled to the first component 31, and the movable element coupling fulcrum 85c provided between the stationary fulcrum 85a and the first component coupling fulcrum 85b in such a manner as to be coupled to the movable element 51. As a result, the ratio of the movement amount of the movable element 51 to the movement amount of the first component 31 can be set while being controlled.

The second component 32 includes the externally threaded section 32d1, and the stationary element 52 includes the nut 52b which is brought into thread engagement with the externally threaded section 32d1. As a result, by moving the stationary element 52, the initial value of the tension resulting from the coil springs 53 which are extended between the movable element 51 and the stationary element 52, that is, the control amount of the effector apparatus 100 which corresponds to the force with which the electric guitar 200 is pressed downwards can be controlled. As a result, the coil springs 53 can be prevented from being expanded by the own weight of the electric guitar 200.

Additionally, the first component 31 or the second component 32 includes the externally threaded section 32d1, and the movable element 51 or the stationary element 52 includes the nut 52b configured to be brought into thread engagement with the externally threaded section 32d1. In the present embodiments, the externally threaded section 32d1 is provided on the second component 32, and the nut 52b is provided in the stationary element 52. As a result, the tensions applied to the first component 31 and the second component 32 can be controlled, and the extent of the effect which corresponds to the force with which the electric guitar 200 is pressed downwards can be controlled.

The stopper 32d5 is provided at the distal end of the externally threaded section 32d1 to restrain the escape of the externally threaded section 32d1 from the nut 52b. As a result, the second shaft element 32d can be restrained from escaping from the nut 52b.

The electronic apparatus 10 includes the case 20 which accommodates the generator 60, and the case 20 includes the sliding rails 20a. Then, the movable element 51 includes the sliding elements 54 configured to be guided by the sliding rails 20a. As a result, the smooth rectilinear movement of the movable element 51 can be realized.

The first component 31 or the second component 32 includes the pin 31e which extends at right angles to the direction in which the tension is applied, and the movable element 51 includes the multiple grooves 51b2 provided radially and with which the pin 31e is brought into engagement. In the present embodiments, the pin 31e is provided on the first component 31. As a result, the orientation of the case 20 can easily be changed.

The rotation amount of the rotational movement generated by the generator 60 which corresponds to the change amount of the distance between the first component 31 and the second component 32 falls within the range of the electrical effective rotation angle of the rotation detection device 40. As a result, the generator 60 can be made to cover the whole range of the electrical effective rotation angle of the rotation detection device 40.

The electronic apparatus 10 includes the communication unit 75 configured to communicate with the receiver 150, which is the external device, and the communication unit 75 generates a sound to which the effect is applied by sending the detection value detected by the rotation detection device 40 to the receiver 150. As a result, the effector apparatus 100 can be controlled while the electric guitar 200 is being played without being restricted by the position of the effector apparatus 100 by employing the electronic apparatus 10 which can control the effector apparatus 100 while recognizing the extent of the effect as the physical movement amount.

Thus, the embodiments of the present disclosure have been described heretofore, however, these embodiments are presented as examples, and hence, there is no intention to limit the technical scope of the present disclosure by those embodiments. These novel embodiments can be carried out in other various forms, and various omissions, replacements, and modifications can be made thereto without departing from the spirit and scope of the present disclosure. Those resulting embodiments and modified examples thereof are included in the scope and gist of the present disclosure and are also included in the scope of disclosures claimed for patent under claims below and their equivalents.

What is claimed is:

1. An electronic apparatus for musical instruments comprising:
a first component configured to be coupled to a strap;
a second component configured to be coupled to a musical instrument;
a generator configured to generate a rotational movement in accordance with a distance between the first component and the second component, which is configured to change based on a tension applied to at least one of the first component or the second component; and
a rotation detection device configured to detect a rotation amount of the rotational movement generated by the generator.

2. The electronic apparatus for musical instruments according to claim 1, comprising:
a slider configured to change the distance between the first component and the second component based on the tension.

3. The electronic apparatus for musical instruments according to claim 2,
wherein the slider comprises an expandable element configured to expand or contract in accordance with the tension.

4. The electronic apparatus for musical instruments according to claim 1, further comprising:
a movable element coupled to the first component and configured to move in accordance with the tension,
wherein the generator comprises a lever configured to couple the movable element and the rotation detection device together, and generates the rotational movement by rotating the lever in accordance with a movement of the movable element.

5. The electronic apparatus for musical instruments according to claim 4,
wherein the movable element comprises a pin,
wherein the lever comprises a groove with which the pin is brought into sliding engagement, and
wherein the lever rotates as a result of the pin sliding within the groove as the movable element moves.

6. The electronic apparatus for musical instruments according to claim 4, further comprising:
a stationary element coupled to the second component and configured not to move in accordance with the tension.

7. The electronic apparatus for musical instruments according to claim 6, further comprising:
an expandable element provided between the movable element and the stationary element and configured to expand or contract in accordance with the tension.

8. The electronic apparatus for musical instruments according to claim 7,
wherein the expandable element is a coil spring.

9. The electronic apparatus for musical instruments according to claim 4,
wherein the first component is coupled to the movable element via a link mechanism comprising a link, and
wherein the link comprises a stationary fulcrum provided at one end of the link, a first component coupling fulcrum provided at an other end of the link and coupled to the first component, and a movable element coupling fulcrum provided between the stationary fulcrum and the first component coupling fulcrum and coupled to the movable element.

10. The electronic apparatus for musical instruments according to claim 6,
wherein the first component or the second component comprises an externally threaded section, and
wherein the movable element or the stationary element comprises a nut configured to be brought into thread engagement with the externally threaded section.

11. The electronic apparatus for musical instruments according to claim 10, further comprising:
a stopper provided at a distal end of the externally threaded section, the stopper being configured to restrain the externally threaded section from escaping from the nut.

12. The electronic apparatus for musical instruments according to claim 4, further comprising:
a case configured to accommodate the generator,
wherein the case comprises a sliding rail, and
wherein the movable element comprises a sliding element configured to be guided by the sliding rail.

13. The electronic apparatus for musical instruments according to claim 4,
wherein the first component or the second component comprises a pin extending at right angles to a direction in which the tension is applied, and
wherein the movable element comprises multiple grooves provided radially and with which the pin is brought into engagement.

14. The electronic apparatus for musical instruments according to claim 1,
wherein the rotation amount of the rotational movement generated by the generator which corresponds to a change amount of the distance between the first component and the second component falls within a range of an electrical effective rotation angle of the rotation detection device.

15. The electronic apparatus for musical instruments according to claim 1, further comprising:
a communication unit configured to communicate with an external device,
wherein the communication unit generates a sound to which an effect is applied by sending a detection value detected by the rotation detection device to the external device.
